(19) United States
(12) Patent Application Publication
(10) Pub. No.: US 2010/0194685 A1
(43) Pub. Date: Aug. 5, 2010

(54) Information processing apparatus

(76) Inventor: Jaewoo Shim, Seongnam-si (KR)

Correspondence Address: Kirk Hermann, 150 Cerro Vista Way, Anaheim, CA, 92807, US

(21) Appl. No.: 12/454,506

(22) Filed: May 19, 2009

Related U.S. Application Data
(63) Continuation-in-part of application No. 12/454,103, filed on May 12, 2009.

(30) Foreign Application Priority Data
Feb. 4, 2009 (KR) 10-2009-8977

(51) Int. Cl. G06F 3/033

(52) U.S. Cl. 345/157

(57) ABSTRACT

An information processing apparatus including a key input device and a sensing unit that detects motion and/or sound to adjust a position of a mouse pointer on a display

### CROSS-REFERENCE TO RELATED APPLICATIONS

This is a continuation-in-part application of currently pending U.S. patent application Ser. No. 12454103, entitled “INFORMATION PROCESSING APPARATUS”, which claims the benefit under 35 U.S.C. §119(a) of a Korean patent application filed in the Korean Intellectual Property Office on Feb. 4, 2009 and assigned Serial No. 10-2009-8977, the entire disclosure of these applications is hereby incorporated by reference.

### BACKGROUND OF THE INVENTION

1. Field of the Invention

The present invention relates to an information processing apparatus, and more particularly to, an information processing apparatus including a key input device and a sensing unit that detects motion and/or sound to adjust a position of a mouse pointer on a display.

2. Description of the Related Art

General information processing apparatuses, such as personal computers, notebook computers, word processors, and communication terminals, are designed to have a mouse installed therein so as to promote the user's convenience when a position needs to be changed on an information document which is being prepared, edited and read. Information processing apparatuses in which the mouse is installed allow the easy change of a position on the information document as desired by the corresponding user by moving a mouse pointer on a display by a distance that the mouse moves.

In particular, notebook computers, for which a demand has increased owing to their mobility, have a touchpad installed therein as a device for moving and clicking the mouse pointer on the display. The touchpad has an aesthetic appearance, and a light touch with the finger is the same as a click of a left button of an external mouse and thus users can use the notebook computers without an installed click button installed on the touchpad.

However, when the finger touches the touchpad to move the mouse pointer, a click of the touchpad is automatically performed due to discontinuous contact with the finger, which caused an error. Further, when dragging is performed with the mouse pointer, the finger moves above the touchpad and another finger must press a fixed click button, which also causes user's inconvenience. Touching and no touching of a finger can be performed on the touchpad several times to move the mouse pointer due to a small area of the touch pad, which makes it difficult to move the mouse pointer as compared to the external mouse, and thus the speed of computer usage becomes slower.

Thus, there are many cases when a user carries a general external mouse when using a notebook computer. However, the user frequently needs to move the notebook computer itself, which provides the user with inconvenience in connecting the external mouse to a connection terminal of the notebook computer and in additionally carrying the external mouse when not in use.

### SUMMARY OF CERTAIN INVENTIVE ASPECTS

The apparatuses of the invention each have several aspects, no single one of which is sole responsible for its desirable attributes. Without limiting the scope of this invention as expressed by the claims which follow, its more prominent features will now be discussed briefly.

One embodiment includes an information processing apparatus. The information processing apparatus includes a main body and a sensing unit. The main body includes a key input device. The sensing unit is installed is in one side of the key input device, and is configured to detect a movable member to adjust a position of a mouse pointer on a display. The movable member is configured to be moved by an individual's hand.

Another embodiment includes an information processing apparatus. The information processing apparatus includes a main body. The main body includes a key input device, a depressible unit and a sound recognition sensor. The depressible unit includes a plurality of depressible members. Each one of the depressible members is configured to emit at least one sound. Each one of the depressible members is configured to be depressed and, when depressed, to emit at least one of the distinct sounds which differs from the at least one of the distinct sound created by other ones of the depressible members. The sound recognition sensor is configured to detect the at least one distinct sound emitted by each of the plurality of depressible members, wherein the detected the at least one distinct sound emitted by each of the plurality of depressible members controls at least one aspect of the operation of a pointer on a display.

Another embodiment includes an information processing apparatus. The information processing apparatus includes sensing means for detecting movement of an object configured to be moved by a user's hand to adjust a position of a mouse pointer on a display means, adjustment means for changing the spatial orientation of the movement detected by the sensing means and display means for displaying the position of a mouse pointer.

### BRIEF DESCRIPTION OF THE DRAWINGS

FIG. 1 is a perspective view illustrating an exemplary information processing apparatus.

FIG. 2A is a plan view illustrating an exemplary sensing unit.

FIG. 2B illustrates an exemplary use of the exemplary pad and sensing unit shown in FIG. 2A.

FIG. 2C illustrates an exemplary use of exemplary pad and sensing unit shown in FIG. 2A.

FIG. 3A illustrates a plan view of an exemplary sensing unit.

FIG. 3B illustrates an exemplary use of the exemplary pad and sensing unit shown in FIG. 3A.

FIG. 3C illustrates another pad operation status in which a finger is used according to the sensing unit shown in FIG. 3A.

FIG. 4 illustrates a top view of an exemplary sensing unit.

FIG. 5 illustrates a top view of a sensing unit, a scroller, and four depressible members.

### DETAILED DESCRIPTION OF CERTAIN EMBODIMENTS

The following detailed description is directed to certain specific embodiments of the invention. However, the invention can be embodied in a multitude of different ways as defined and covered by the claims.

One embodiment includes an information processing apparatus. The information processing apparatus includes a main body, a sensing unit and a movable pad. The main body includes a key input device. The sensing unit detects a user's motion to adjust a position of a mouse pointer on a display. The movable pad is disposed on the upper side of the sensing unit so as to change the position of the mouse pointer on the display.

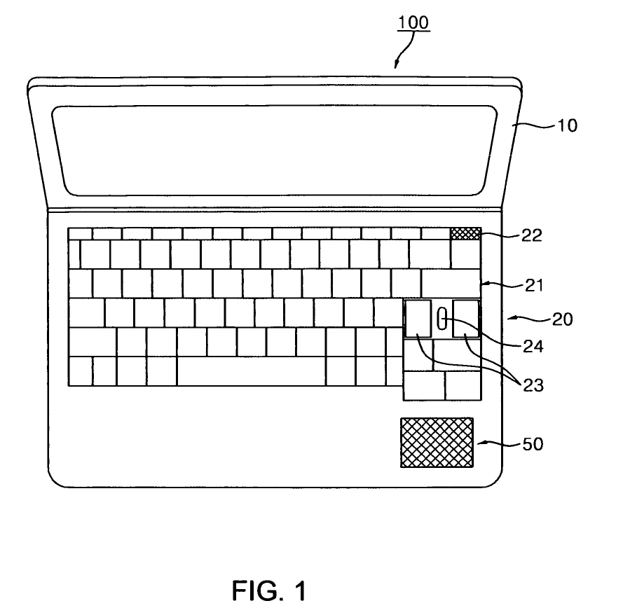

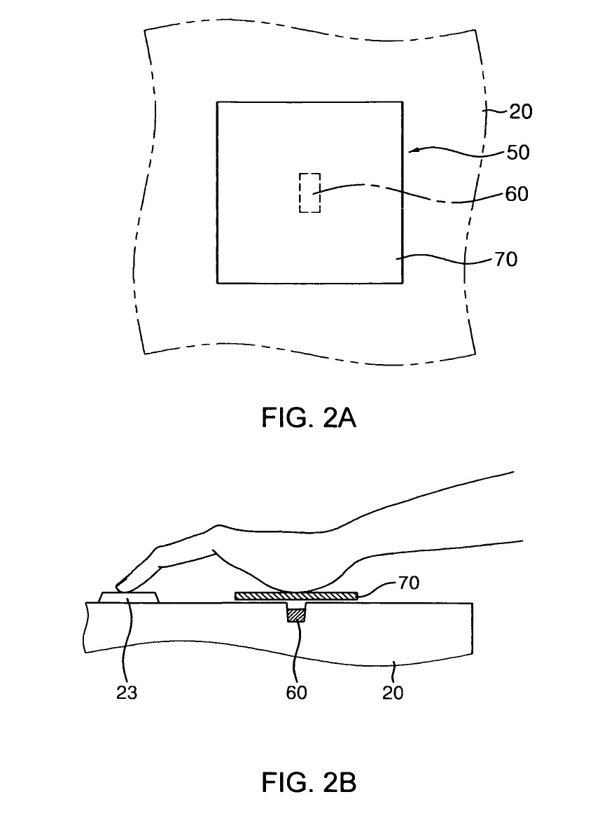

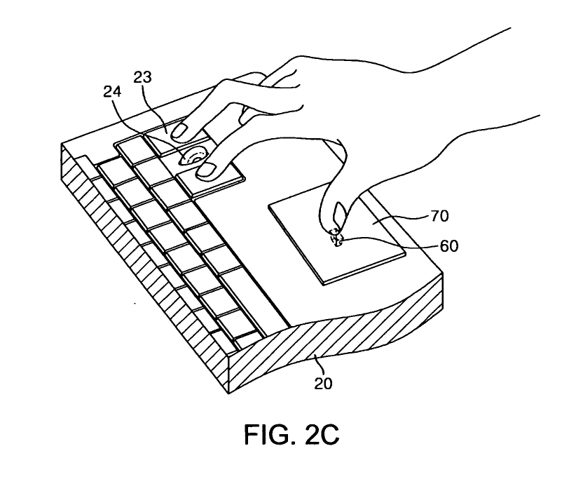

FIG. 1 is a perspective view illustrating an exemplary information processing apparatus 100. FIG. 2A is a plan view illustrating an exemplary sensing unit 60. FIG. 2B illustrates an exemplary use of the exemplary pad 70 and sensing unit 60 shown in FIG. 2A. FIG. 2C illustrates an exemplary use of exemplary pad 70 and sensing unit 60 shown in FIG. 2A.

In one embodiment, the information processing apparatus 100 performs a predetermined operation according to a user's instruction or command. In one embodiment, information processing apparatus 100 can include an electric calculator, a mobile communication terminal, a computer, and the like. In one embodiment, the information processing apparatus can include a mobile computer such as but not limited to a laptop or notebook computer.

FIGS. 1 through 2C illustrate an exemplary information processing apparatus 100, which is a notebook computer. This exemplary information processing apparatus includes a display 10 that allows a user's visible recognition and a main body 20, which is connected to the display 10 and performs an operation. For this embodiment, the main body 20 includes a key input device 21 for receiving a signal from a user and the key input device 21 includes a plurality of buttons used to input a user's predetermined instruction or data in the American Standard Code for Information Interchargecode (ASCII) code. In one embodiment notebook computer 100 may include a signal input member 50, such as a mouse, so as to promote user's convenience when a position needs to be changed on a display for example an information document which is being prepared, edited, or read. In one embodiment, the signal input member 50 is configured to make it possible to easily change a position on the display (such as an information document) as desired by the user by moving a mouse pointer on the display 10.

In one embodiment, when the signal input member 50 is used to input a signal, a device is required for adjusting the position of the mouse pointer on the display 10. In one embodiment, a sensing unit 60 is configured to detect a user's motion. In one embodiment, a sensing unit 60 may be disposed in one side of the key input device 21.

In one embodiment, a pad 70 that is movable up and down left and right so as to change the position of the mouse pointer on the display 10 may be disposed in an upper side of the sensing unit 60.

In one embodiment, when a user detects a movement of the pad 70 through the sensing unit 60, the main body 220 may include a controller (not shown in the figures) that displays the position of the mouse pointer on the display 10 in response to the movement of the pad 70.

In one embodiment, the pad 70 may be installed in the information processing apparatus 100 or may be carried with the user. In one embodiment, when the user uses the information processing apparatus 100, the user may use his/her palm or finger, such as a thumb, to move the pad up and down left and right from the upper side of the sensing unit 60, thereby easily manipulating the position of the mouse pointer.

In one embodiment, an upper side surface of the pad 70 needs to be formed of a less slippery material with finger or the palm and a lower side surface thereof needs to be formed of a freely slippery material from the upper side of the sensing unit 60. In one embodiment, the material of the pad 70 may be suitably used to maintain a predetermined shape. In one embodiment, the pad 70 may be attached to the palm or the finger or may be put on the palm or the finger in the form of a glove.

In one embodiment, at least one of the key input device 21 and the main body 20 may include a position adjustment button 22 used to adjust the position of the mouse pointer to the center of the display 10 when the center portion of the pad 70 is positioned on the upper side of the sensing unit 60. In one embodiment, the position adjustment button 22 may include a simple function key disposed on the key input device 21. In one embodiment the position adjustment button 22 can be used to adjust the position of the mouse pointer when it is necessary to adjust the position of the mouse pointer while either the user is using the information processing apparatus 100 or after the user has completely used the notebook computer 100.

In one embodiment, at least one of the key input device 21 and the main body 20 may include two click buttons 23 used to designate the position of the mouse pointer. In one embodiment, the click buttons 23 have the same function as the left and right buttons of a generally used external 3-button mouse. In one embodiment, if user inputs a signal through the click buttons 23, the information processing apparatus' operating system (OS) is capable of recognizing when a user selects a signal and sends a message of the recognized signal to an application program. In one embodiment, the click buttons 23 may be sufficiently lengthy in order to accommodate all hand sizes and fingers lengths so when the palm is used to move the pad 70, the click buttons 23 may be included in the key input device 21, and when the finger, in particular, the thumb, is used to move the pad 70, the click buttons 23 may be included in a bottom portion or a main body of the key input device 21 according to the user's convenience.

In one embodiment, at least one of the key input device 21 and the main body 20 may include a scroll member 24 used to change the position of the information document that is being read.

In one embodiment, the scroll member 24 may employ a scroll wheel, slide, or button configured to be able to change the position in the information document that is being read. In one embodiment, the scroll wheel has the same function as a scroll wheel of the generally used external 3-button mouse. In one embodiment, when the scroll member is rotated, the scroll wheel performs a function of moving the information document on the display 10 up and down. In one embodiment, the scroll wheel 24 may be configured as a single module or may be disposed between the click buttons 23 like the general external mouse.

In one embodiment, the sensing unit 60 may be integrally formed with the main body 20. In one embodiment, the sensing unit 60 may be integrally formed with the main body 20 in one side of the key input device 21. In one embodiment, the sensing unit 60 is formed in one side of the body 20 and the pad 70 is used to adjust the position of the mouse pointer on the display 10, thus preventing the inconvenience of having to additionally carrying a mouse.

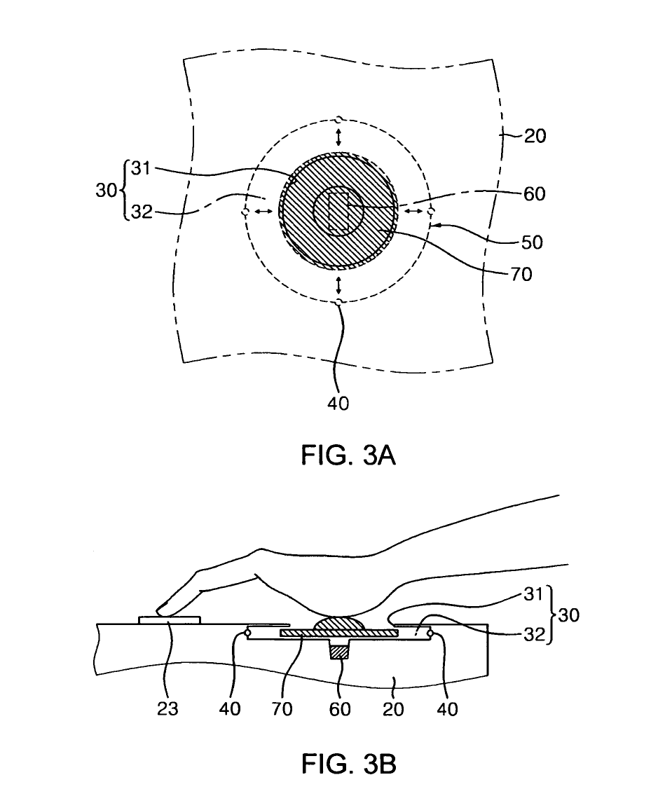

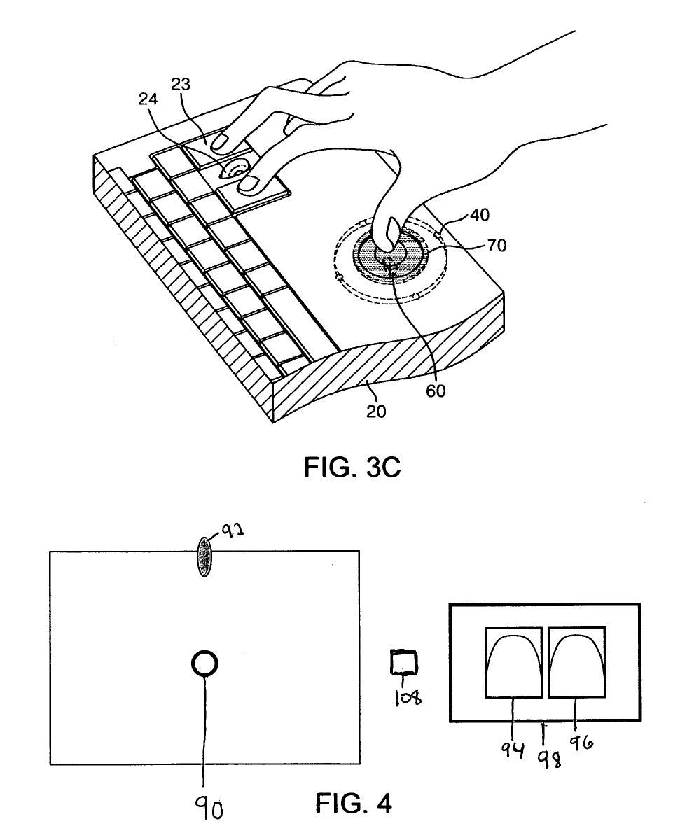

FIG. 3A illustrates a plan view of an exemplary sensing unit 60. FIG. 3B illustrates an exemplary use of the exemplary pad 70 and sensing unit 60 shown in FIG. 3A. FIG. 3C illustrates another pad operation status in which a finger is used according to the sensing unit 60 shown in FIG. 3A.

FIGS. 3A through 3C illustrate exemplary embodiments in which the main body 20 may include a groove portion 30 in the upper side of the sensing unit 60. In one embodiment, the groove portion 30 includes an entrance portion 31 that contacts the exterior and an inside portion 32 that is formed to be greater than a radius of the entrance portion 31 and is curved inside thereof.

In one embodiment the pad 70 is inserted into the portion 32 and may be movable up and down and left and right within the inside portion 32. In one embodiment, the pad 70 is inserted into the inside portion 32. In one embodiment the sensing unit 60 detects any up and down and left and right movement of the pad 70 that are performed by a user so that the position of the mouse pointer on the display 10 changes according to the movement of the pad 70. In one embodiment, the pad is installed in the inside portion 32, thereby preventing the inconvenience of additionally carrying the pad 70. In one embodiment, a user's palm or finger may be used to easily operate pad 70. In one embodiment, the click button 23 may be installed in the key input device 21 and/or the main body 20 in view of the user's convenience.

In one embodiment, the inside portion 32 may include a position sensor 40 in an exterior circumferential surface thereof. In one embodiment, the position sensor 40 allows the position of the mouse pointer to be located on the boundary of the display 10 when the inside portion 32 contacts the pad 70. In one embodiment, when a user powers off the information processing apparatus 100 (for example, a notebook computer) and then powers on the information processing apparatus 100, if the position sensor 40 and the pad 70 contact each other, the mouse pointer is positioned on the display 10 corresponding to the position of the position sensor 40.

In one embodiment, a plurality of position sensors 40 may be formed in the exterior circumferential surface of the inside portion 32 so that the mouse pointer corresponding to the position of the position sensor 40 is positioned on the boundary of the display 10. In one embodiment, the position of the mouse pointer of the display 10 is previously established in a controller of the main body 20 according to the position of the position sensor 40 and the position of the mouse pointer is disposed to correspond to the previously established position of the mouse pointer.

In one embodiment, the sensing unit 60 may include an optical sensor including a light emitting sensor and a light receiving sensor for detecting the movement of the pad 70. In one embodiment, the optical sensor is the same type of sensor that is installed inside the main body 20 and detects an up and down and left and right movement of the pad 70. In one embodiment, various types and shapes of optical sensors for detecting the movement of the pad 70 may be installed by using the light emitting sensor and the light receiving sensor.

The operation of the information processing apparatus of the present invention will now be described.

FIGS. 2B through 3B illustrate exemplary embodiments of an information processing apparatus 100 (for example, a notebook computer). In one embodiment, the sensing unit 60 is configured to detect a user's operation so as to adjust the position of the mouse pointer on the display 10 and is formed in one side of the main body 20. In one embodiment, the sensing unit 60 includes a pad 70 which is disposed in the upper side of the sensing unit 60 and is movable so as to change the position of the mouse pointer.

In one embodiment, if the mouse moves the pad 70 from the upper side of the sensing unit 60 up and down and left and right, the sensing unit 60 detects the movement of the pad 70 and displays the mouse pointer on the display 10 through the controller included in the main body 20.

In one embodiment, a pad 70 is configured to be moved by a user in close proximity to a sensing unit 60. In one embodiment, groove portion 30 includes an inside portion 32 which has a space in which the pad 70 can be moved near. In one embodiment, groove portion 30 is formed in the upper side of the sensing unit 60 and the pad 70 is configured to be inserted into the inside portion 32 where it is capable of being moved up and down and left and right.

In one embodiment, the notebook computer 100 may include the position adjustment button 22 so as to adjust the position of the mouse pointer on the display 10. In one embodiment, when a center of the pad 70 is disposed in the upper side of the sensing unit 60, the position adjustment button 22 is capable of allowing the mouse pointer on the display 10 to be positioned in the center of the pad 70. In one embodiment, when the information processing apparatus 100 (for example, a notebook computer) is used after being booted by using the position adjustment button 22, an initial position of the mouse pointer may be established.

In one embodiment, at least one of the key input device 21 and the main body 20 includes the click button 23 and the scroll member 24. In one embodiment, the scroll member 24 includes a scroll wheel having a general mouse function, which thus increases the user's convenience.

In one embodiment, when a pad 70 is inserted into the inside portion 32, since the position of the mouse pointer may be changed according to the power on/off of the information processing apparatus 100 (for example, a notebook computer), the plurality of the position sensors 40 are installed in the exterior circumferential surface of the inside portion 32 so that the mouse pointer is positioned on the display 10 corresponding to positions sensors 40 when the pad 70 contacts the position sensors 40.

In one embodiment, the information processing apparatus 100 makes it possible to easily adjust the position of the mouse pointer on the display 10 and prevents the user from having to carry an additional external mouse.

In one embodiment, hardware and/or software (such as but not limited to programming, firmware and/or a logic chip) is configured to be able to change the spatial orientation of the signal received by the sensing unit 60. In one embodiment, hardware and/or software (such as but not limited to programming, firmware and/or a logic chip) is configured to be able to change the spatial orientation of the signal received by the sensing unit 60. In one embodiment, hardware and/or software (such as but not limited to programming, firmware and/or a logic chip) is configured to be able to change the spatial orientation of the signal received by the sensing unit 60 by reversing its X-Y Cartesian orientation prior to displaying it.

FIG. 4 illustrates a top view of an exemplary sensing unit 90. In this embodiment, sensing unit 90 includes a scroller 92 that can be manipulated to change at least one aspect of the operation of a pointer on a display, a depressible unit 98 (for example, a depressible pad) and a sound recognition sensor 108. In one embodiment, depressible members 94 and 96 are configured to receive an individual's fingers in which each of the depressible members 94 and 96 when depressed gives off a separate distinct sound whereby the sound recognition sensor can detect and differentiate the distinct sounds to thereby allow for the change of at least one aspect of the operation of a pointer on a display (for example, to click on a hyperlink on a web page displayed on a monitor). In one embodiment, sound recognition sensor 108 is installed into the information processing apparatus (such as a notebook computer). In one embodiment, scroller can change a position of a mouse pointer on a display.

In one embodiment, sound recognition sensor is configured to detect the at least one distinct sound emitted by each of the plurality of depressible members, wherein the detected the at least one distinct sound emitted by each of the plurality of depressible members controls at least one aspect of the operation of a pointer on a display. In one embodiment, at least one aspect of the operation of a pointer on a document being display includes providing control over a pointer visually shown on a display. In one embodiment, at least one aspect of the operation of a pointer on a display includes clicking on an area of a displayed document or webpage. In one embodiment, at least one aspect of the operation of a pointer on a document being display includes providing input to control information which information is displayed.

In one embodiment, the depressible members 94 and 96 are each a click button that is neither connected to an electric circuit nor to an electrical or chemical power source such as a battery. In one embodiment, each of the depressible members 94 and 96 is configured to emit a different sound (for example, a different clicking sound) when depressed (for example by an individual's finger). In one embodiment, each of the depressible members 94 and 96 is configured to emit a distinct and different sound (for example, a sound with a distinct wavelength) when depressed (for example by an individual's finger) and sound recognition hardware and/or software configured to recognize the distinct and different sounds emitted by the depressible members 94 and 96.

In one embodiment, the depressible members 94 and 96 are configured to receive an individual's finger. In one embodiment, the depressible members include a groove to ensure that an individual's second and third fingers (in which the thumb is considered the first finger) fit within the grooves for example to allow an individual to control a pad's movement above a sensing unit.

In one embodiment, an information processing apparatus includes at least one depressible button. In one embodiment, an information processing apparatus includes at least four buttons, wherein at least two of the buttons are configured to be used by a left handed person and at least two of the buttons are configured to be used by a right handed person.

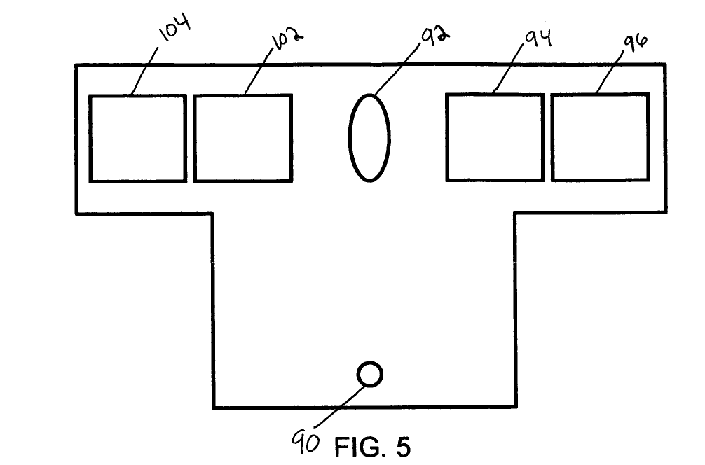

FIG. 5 illustrates a top view of a sensing unit 90, a scroller 90, and four depressible members 94, 96, 102 and 104, in which depressible members 94 and 96 are configured to be used by a right handed person (known as a “righty”) and depressible members 102 and 104 are configured to be used by a left handed person (known as a “lefty”). One embodiment includes hardware and/or software configured to change the function of the depressible members 94, 96, 102 and 104.

One embodiment includes a device control program configured to allow a user to select between using the righty or lefty depressible members. One embodiment includes a device control program configured to allow a user to select between using the righty or lefty depressible members with the unselected depressible members capable of being set to function for other uses for example but not limited to a mouse pointer jump button to allow a user to change the position of a mouse cursor from a notebook computer screen to an additionally installed monitor that is connected to the notebook computer.

In one embodiment, depressible members can be configured as an integral part of a keyboard.

In one embodiment, the information processing apparatus includes a movable member configured to be sensed when moved above an optical sensor, and a storage means configured to store the movable member. In one embodiment, the movable member is a pad. In one embodiment, the storage means is a slot. In one embodiment the storage means is a clipping structure configured to repeatedly clip and unclip the movable member as it is stored and then taken out of storage.

One embodiment includes a double layer structure (for example, two plates) between which a movable member (for example, a pad) can be stored.

In one embodiment, the information processing apparatus includes a durable coating and/or a plate material configured to withstand repeated contact of by a movable member.

In one embodiment, the information processing apparatus is partially covered (for example, the area that comes into physical contact with the movable member) by a removable and/or replaceable sticker or thin plate.

In one embodiment, movable member (for example, a pad) includes a nonslip or slip resistant material on one side so that when this side is in contact with an individual's finger it creates a de facto unitary structure with the individual's finger. In one embodiment, the movable member is configured to have a relatively slippery surface. In one embodiment, the moveable member includes a semi-opaque side.

In one embodiment, movable member (for example, a pad) is configured to include integrally include a ring-like structure that can be worn by one or more fingers to maintain physical control of the movable member.

1. An exercise device for facilitating limb movement by the user of a walker having two inverted U-shaped legs, comprising:
a cross bar having a length and first and second ends;
a cable support system operatively associated with said cross bar, including a cable spanning the length of said cross bar, and having first and second ends, the first end of the cable extending from the first end of the crossbar;
a resistance member operatively engaged with the cable support system and positioned proximate said second end of the cable, the resistance member comprising at least one stretchable band disposed on at least one slidable catch panel and at least one selectively stationary catch, said slidable catch panel being longitudinally spaced from said selectively stationary catch;
a stirrup capable of receiving a limb to be exercised attached to said first end of the cable; and
a connector having arms for engaging the legs of a walker.

2. The exercise device of claim 1, wherein said connector comprises a base bar that extends transversely to the cross bar from a first end to a second end.

3. The exercise device of claim 2, wherein said connector comprises a connection member disposed between and attachable to both said cross bar and base bar.

4. The device of claim 3, wherein said base bar is engageable with two adjacent legs of said walker.

5. (canceled)

6. The device of claim 1, wherein said cross bar is selectively rotatable about a vertical axis passing through said connection member.

7. The device of claim 1, wherein the resting height of said stirrup is adjustable.

8. The device of claim 1, wherein the degree of resistance delivered by said resistance member is adjustable.

9. (canceled)

10. The device of claim 1, wherein said at least one slidable catch panel further comprises a guide member.

11. The device of claim 10, wherein a portion of the cable adjacent the second end of the cable is engaged with said guide member so that when the first end of the cable is pulled said portion of the cable and said at least one slidable catch panel move in a direction away from the resistance member.

12. The device of claim 10, wherein the degree of resistance can be increased or decreased by selectively increasing or decreasing the longitudinal spacing between said at least one slidable catch panel and said at least one selectively stationary catch.

13. The device of claim 1, wherein the degree of resistance can be altered by substituting different stretchable bands.

14. (canceled)

15. The device of claim 1, comprising a stopper mechanism located on the first end of said cable between said stirrup and said first end of the cross bar.

16. The device of claim 15, wherein the location of said stopper mechanism along said cable is adjustable.

17. The device of claim 1, wherein the cross bar is a U-bar defining a U-shaped channel and the cable support system comprises at least two guide members disposed within said U-shaped channel, whereby said cable is disposed on said guide members and said guide members facilitate lateral movement of the cable.

18. The device of claim 3, wherein the connection member spans at least the length of and surrounds said resistance member on at least three sides.

19-20. (canceled)

21. An exercise device for facilitating limb movement by the user of a walker having two inverted U-shaped legs, comprising:
a cross bar having a length and first and second ends;
a cable support system operatively associated with said cross bar, including a cable spanning the length of said cross bar, and having said first end extending from the first end of the crossbar;
a resistance member attached to said second end of the cable;
a stirrup capable of receiving a limb to be exercised attached to said first end of the cable; and
a connection unit for rigidly connecting the exercise device to a walker, the connection unit comprising
a base bar that extends transversely to the cross bar from a first end to a second end;
a connection member disposed between and attachable to both said cross bar and base bar; and
a support unit rigidly attached to said connection member between the base bar and the cross bar, said support unit defining a bottom surface engagable with one of the inverted U-shaped legs of said walker.

22. The device of claim 21, wherein the resistance member is a weight.

23. The device of claim 21, comprising a stopper mechanism located on the first end of said cable between said stirrup and said first end of the cross bar.

24. The device of claim 21, wherein the connection member spans at least the length of and surrounds said resistance member on at least three sides.

25. The device of claim 21, wherein the degree of resistance is adjustable.
